(19) United States
(12) Patent Application Publication
(10) Pub. No.: US 2011/0048842 A1
(43) Pub. Date: Mar. 3, 2011

(54) System, device and method for providing audible sounds from a surface

(76) Inventor: Charles Timberlake Zeleny, Baltimore, MD (US)

(21) Appl. No.: 12/461,980

(22) Filed: Aug. 31, 2009

(51) Int. Cl. G10K 15/04; B32B 3/00

(52) U.S. Cl. 181/142; 428/156

(57) ABSTRACT

A method, system and device for reproducing sound. The device may include an elongated strip of material having a ridge substantially extending the length and width of the elongated strip. The elevation of the ridge may vary along the length of the elongated strip to produce sound when contacted by a wheel of a vehicle travelling substantially along the length of the elongated strip.

### BACKGROUND

Embodiments of the present subject matter generally relate to a device, system and method for reproducing sound. It is desirable in many cases to integrate sound information into everyday life. For example, printed products such as magazines, packages, books, greeting cards and the like may provide a sound track that gives the printed product an additional function as a sound reproducing apparatus thereby supplementing any visual information with acoustic information.

For example, U.S. Pat. No. 2,997,306, entitled, “Book with Talking Pages,” and U.S. Pat. No. 2,546,680, entitled, “Sound Illustrated Book,” generally discloses a sound track incorporated into the pages of the book by embossing or affixing a stiff material of paper or plastic onto the page, the material having etchings being perpendicular to the direction of travel of a sound reader, e.g., a fingernail, zipper mechanism or other reader. Other similar references also include U.S. Pat. No. 695,159, entitled, “Apparatus for Reproducing Sounds,” U.S. Pat. No. 6,296,926, entitled “Embossed Sound Track,” and U.S. Pat. App. Pub. No. 2004/0074799, entitled, “Pouch with Sound Strip,” each of which provide similar compressible or multilayered sound strips. Each of these listed references are incompatible with producing sound in a more environmentally challenging scenario such as the production of sound for vehicular traffic.

Other references have addressed this need. For example, Japanese Pat. Pub. No. JP02008401, entitled, “Acoustic Road,” generally discloses a system having trench zones and flat zones, each of which are perpendicular to the travel of a wheeled vehicle. Each of these trench zones has a shape corresponding to a desired sound and content volume in a specified unit length. The flat zones are formed among the trench zones and correspond to a desired rhythm. Thus, when a vehicle travels on a pavement surface having these trench zones at a predetermined speed, music only in the form of tones may be produced. Because of limitations in its design, this reference, however, cannot be utilized to verbally instruct or direct occupants or users of a vehicle or provide advertisements thereto. Recordings of the human voice and more exact audio reproductions than just tones are not possible.

Thus, there is an unmet need to provide directions, instructions, warnings, advertisements, and other verbal/musical sounds to occupants or users of wheeled vehicles.

### SUMMARY

One embodiment of the present subject matter provides a device for reproducing sound. The device may include an elongated strip of material having a ridge substantially extending the length and width thereof, where the elevation of the ridge varies along the length of the elongated strip to produce sound when contacted by a wheel of a vehicle travelling substantially along the length of the elongated strip.

Another embodiment of the present subject matter may provide another device for reproducing sound. The device may include an elongated strip of material having a channel substantially extending down the length of the elongated strip, where a portion of the channel varies elevationally and laterally to produce sound when contacted by a wheel of a vehicle travelling substantially along the length of the elongated strip.

A further embodiment of the present subject matter provides a system for reproducing sound. The system may include a surface having a first channel etched therein, and an elongated strip of material affixed in the first channel. The elongated strip may include a second channel substantially extending down the length and width of the elongated strip where the second channel varies elevationally along the length of the elongated strip to produce sound when contacted by a wheel of a vehicle travelling substantially along the length of the elongated strip.

One embodiment of the present subject matter provides another system for reproducing sound. The system may include a surface having a first channel etched therein, and an elongated strip of material affixed in the first channel. The elongated strip may have a second channel substantially extending down the length the elongated strip where the second channel varies elevationally and laterally to produce sound when contacted by a wheel of a vehicle travelling substantially along the length of the elongated strip.

Another embodiment of the present subject matter provides a method for reproducing sound. The method may comprise providing a surface upon which vehicular traffic can travel, and affixing an elongated strip of material to the surface. The elongated strip may include a ridge substantially extending the length and width of the elongated strip, where the ridge has an elevation varying along the length of the elongated strip. The method may also comprise producing sound when the elongated strip is contacted by a wheel of a vehicle travelling along the length of the elongated strip.

An additional embodiment of the present subject matter provides a method for reproducing sound. The method may comprise providing a surface upon which vehicular traffic can travel, and embedding an elongated strip of material into the surface. The elongated strip may include a channel substantially extending the length of the elongated strip where the channel has a trough that varies elevationally by a plurality of gradual rises and falls along the length of the elongated strip and has one or more walls that vary laterally by a plurality of gradual excursions and incursions out from or towards a longitudinal centerline of the channel along the length of the elongated strip. The method may also comprise producing sound when the elongated strip is contacted by a wheel of a vehicle travelling along the length of the elongated strip.

These embodiments and many other objects and advantages thereof will be readily apparent to one skilled in the art to which the invention pertains from a perusal of the claims, the appended drawings, and the following detailed description of the embodiments.

### BRIEF DESCRIPTION OF THE DRAWINGS

Various aspects of the present disclosure will be or become apparent to one with skill in the art by reference to the following detailed description when considered in connection with the accompanying exemplary non-limiting embodiments.

FIG. 1 is a perspective representation of one embodiment of the present subject matter.

FIG. 2a is a cross section of the embodiment of FIG. 1 along line X-X.

FIG. 2b is a cross section of the embodiment of FIG. 1 along line Y-Y.

FIG. 3 is a perspective representation of another embodiment of the present subject matter.

FIG. 4 is a perspective representation of a further embodiment of the present subject matter.

FIG. 5 is a perspective representation of another embodiment of the present subject matter.

FIGS. 6a-6c are top plan depictions of a plurality of exemplary channels placed side-by-side.

FIG. 7 is a block diagram depicting an embodiment of the present subject matter.

FIG. 8 is a block diagram depicting a further embodiment of the present subject matter.

### DETAILED DESCRIPTION

With reference to the figures where like elements have been given like numerical designations to facilitate an understanding of the present subject matter, the various embodiments of a system, device and method for providing audible sounds from a surface are herein described.

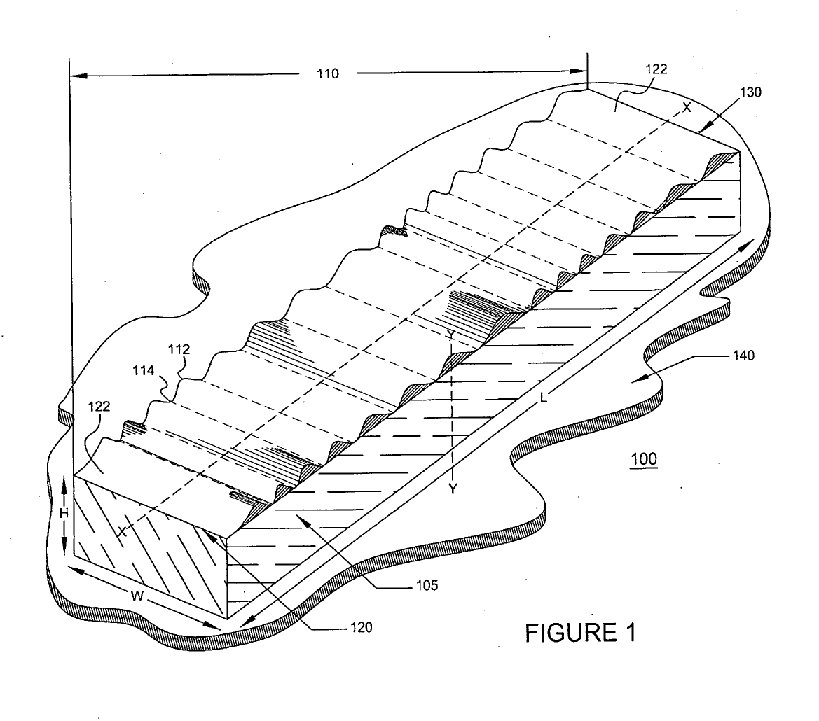

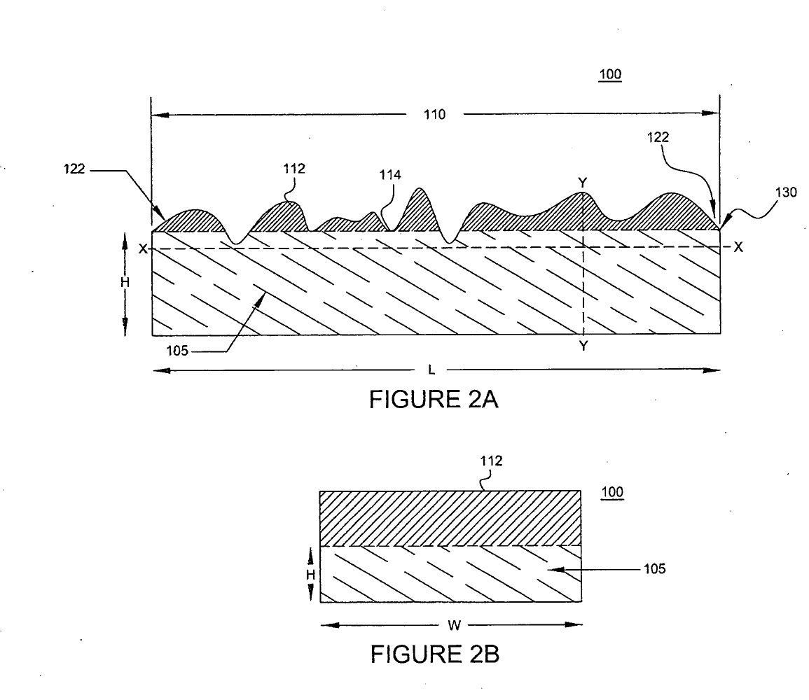

FIG. 1 is a perspective representation of one embodiment of the present subject matter. FIG. 2a is a cross section of the embodiment of FIG. 1 along line X-X, and FIG. 2b is a cross section of the embodiment of FIG. 1 along line Y-Y. With reference to FIGS. 1, 2a and 2b, one embodiment of the present subject matter may be a device 100 having a predetermined length (L), width (W) and height (H). In one non-limiting embodiment, the length of an exemplary device may be approximately fifty feet, the width approximately two and one half feet and the height approximately five inches. Of course, these dimensions are exemplary only and should not limit the scope of the claims appended herewith as varying dimensions are envisioned for embodiments of the present subject matter depending upon the advertisements, warnings, etc. requested by users of the device 100. By way of further example, embodiments of the present subject matter may provide an exemplary width as wide as an average tire or twice as wide as an average tire. Additionally, some embodiments of the present subject matter may be spread across entire lanes of a road or surface to, for example, notify occupants of a vehicle of an oncoming toll booth, hazard, etc. Further, the more profound the height of an exemplary device from the base thereof, the louder the emanating sound. Thus embodiments of the present subject matter may utilize the tires of a vehicle as a speaker and/or as a means to reverberate the oscillations received by the vehicle. It is also envisioned that, depending upon the type of vehicle expected on a particular surface, e.g., car, truck or bus on a roadway, Segway on a sidewalk, airplane on a landing strip, etc., the width of the respective device may change as a function of the average tire width and/or the series of elevations and/or depressions in or on the device may change in frequency as a function of the average speed of the respective vehicle. It should be noted that for vehicles having two or more axles, an echo may be produced during travel over embodiments of the present subject matter; however, these echoes are reduced at higher speeds.

With continued reference to FIGS. 1, 2a and 2b, the device 100 may be an elongated strip or belt of material having a raised portion or ridge 105 with a series 110 of elevations 112 and depressions 114 extending along the length of the device 100. An exemplary material may be, but is not limited to, a substantially incompressible material. Such materials may be, for example, aluminum, steel, other metals, polymers, concrete, asphalt and combinations thereof. Of course, the beginning 120 and/or terminus 130 of the series 110 may be provided with a bevel 122 to prevent any disturbing crack or noise upon contact by a travelling wheel. The raised portion or ridge 105 extends both along the length and width of the device 100; however, the elevation of the ridge 105 may vary only with respect to the length of the device rather than the width. The series 110 of elevations 112 and depressions 114 may be designed to produce predetermined sounds such as a voice, chordal music, a melody, both a voice and melody, an advertisement, a warning, directions, and combinations thereof; in essence, absolutely any previously recorded material may be reproduced using embodiments of the present subject matter. Thus, the elevations 112 and depressions 114 may vary by a plurality of gradual and/or sharp rises and falls along the length of the device 100.

These prerecorded sounds may be audible to occupants and users of wheeled vehicles having one or more wheels in contact with the device 100. Additionally, as the wheeled vehicle varies its speed, the frequency of any produced sound may also vary with the speed of the vehicle. Thus, it is envisioned that speed signs or other visual informative signals may be provided on respective portions of a roadway or sidewalk to alert users of vehicles of a proper speed to hear the auditory directions, advertisements, etc.

The device 100 may be affixed to a substantially planar surface 140 using a bonding mechanism such as, but not limited to, adhesives, glues, spikes, bolts, other mechanical fasteners, etc. Exemplary surfaces 140 may be, but are not limited to, a sidewalk, roadway, landing strip, or other surface contacted by wheeled vehicles such as a car, Segway, truck, bus, airplane, etc. While not shown, the device 100 may include an elongated substrate, such as a polymer substrate, intermediate the device 100 and surface 140 to which the device 100 is affixed. This substrate may act as an interface between the device 100 and surface 140 and account for any differences in thermal expansion and contraction between the device and surface materials. In another embodiment of the present subject matter, the device 100 may be embedded in the surface 140.

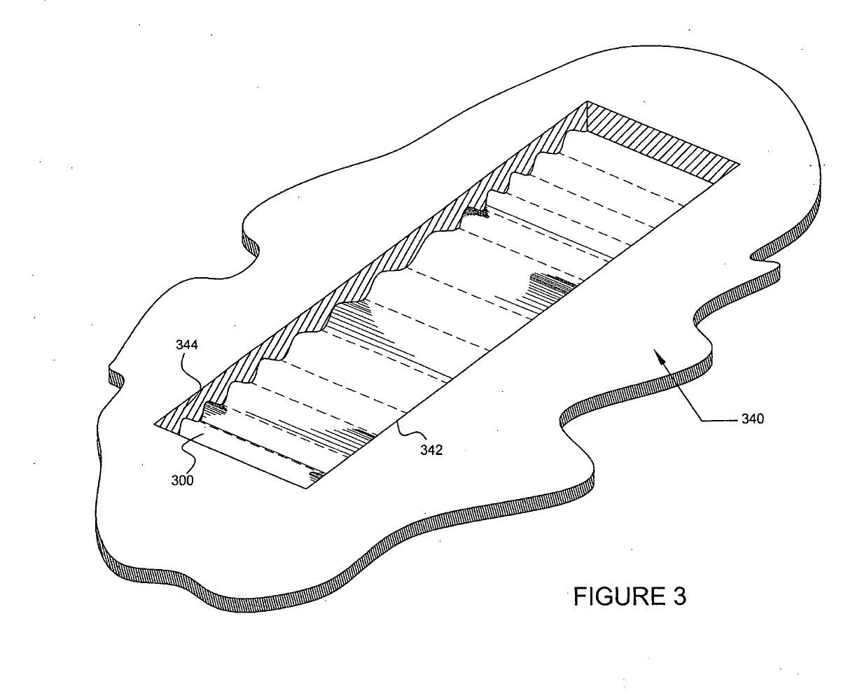

FIG. 3 is a perspective representation of another embodiment of the present subject matter. With reference to FIG. 3, the embodiment may include a surface 340 having a first channel 342 etched therein where a device 300 is affixed in the first channel 342. The device 300 may include a second channel 344 substantially extending down the length and width of the device 300 where the second channel 344 varies elevationally along the length of the device to produce sound when contacted by a wheel of a vehicle travelling along the length of the device 300. In one embodiment, the shape of the first and second channels 342, 344 may be substantially similar; therefore, each may vary elevationally by a plurality of gradual rises and falls along the length of the device 300. While not shown, an elongated substrate may also be provided between the device 300 and the surfaces of the first channel 342 to act as an interface between the device 300 and surface 340 and account for any differences in thermal expansion and contraction between the device and surface materials. In another embodiment, the device 300 may be substantially similar to the device 100 depicted in FIGS. 1, 2a and 2b.

In another embodiment of the present subject matter, cars and other vehicles having one or two axles may have the right front tire produced or retrofitted with a rigid rod of steel leading directly to an interior air motion transformer (similar to analog record players) and in accordance with analog acoustic telegraphing, provide a louder audio experience from the road and into the cabin or simply a louder report for a Segway driver.

In yet another embodiment of the present subject matter, the vehicle may be produced or retrofitted, in the case of a vehicle having two axles, with a fifth, smaller, transmitter wheel extruding from the right front of the vehicle and acting as a needle in a record groove. The fifth wheel leads via an acoustically conductive rigidity (or material) to an interior air motion transformer. This wheel assembly may in one embodiment contain a separate shock absorption method from the other wheels of the vehicle. In the case of the Segway, this may be a third wheel off one of the two wheels. In both cases, however, this wheel may also have built into its assembly, a swivel and/or a spanner that generally allow for driver error in keeping the wheel in a groove(s) of an embodiment of the present subject matter.

Further embodiments of the present subject matter may also be employed in low speed situations to encompass the use of exemplary devices for a wheelchair. Such a vehicle may, in one embodiment, have a tire acting as a stylus-transmitter or may be fitted with a ferrule utilized as the stylus-transmitter as a ‘dragged’ identification cane for the blind. In such embodiments, the tire or stylus-transmitter may contact or engage exemplary devices and provide directions, instructions, or other prerecorded audio to users of the wheelchair.

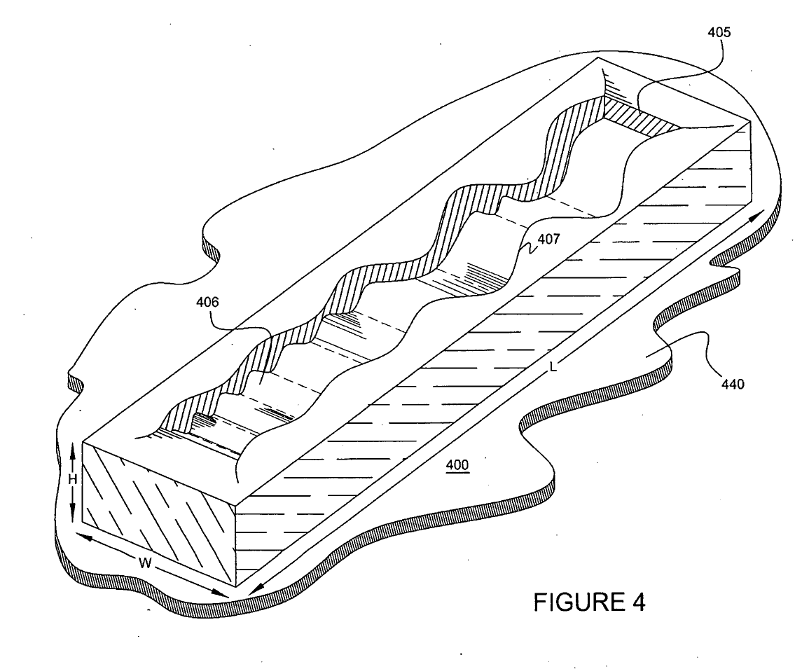

FIG. 4 is a perspective representation of a further embodiment of the present subject matter. With reference to FIG. 4, one embodiment of the present subject matter may be a device 400 having a predetermined length (L), width (W) and height (H). In one non-limiting embodiment, the length of an exemplary device may be approximately fifty feet, the width approximately two and one half feet and the height approximately five inches. Of course, these dimensions are exemplary only and should not limit the scope of the claims appended herewith as varying dimensions are envisioned for embodiments of the present subject matter depending upon the advertisements, warnings, etc. requested by users of the device 400 and as a function of the speed, type of vehicle, width of average tire, etc. expected on the surface or device 400. The device 400 may be an elongated strip or belt of material having a channel 405 (which may be raised or not) substantially extending down the length of the device 400. An exemplary material may be, but is not limited to, a substantially incompressible material. Such materials may be, for example, aluminum, steel, other metals, polymers, concrete, asphalt and combinations thereof. A portion of the channel 405, such as the trough 406, may vary elevationally along the length thereof. Further the walls 407 of the channel 405 may vary laterally along the length thereof. This elevational and lateral variation may produce sound when contacted by a wheel of a vehicle travelling substantially along the length of the device 400. For example, a wheel in contact with the channel 405 may, due to the elasticity of the rubber or vulcanized rubber, deflect into the channel 405 and may act as a stylus or needle which reads the elevational and/or lateral variations in the channel 405. In one embodiment, the elevation of the trough 406 may vary only with respect to the length of the device 400 rather than the width.

In another embodiment, the elevation of the trough 406 may vary by a plurality of gradual and/or sharp rises and falls along the length of the channel 405. Further, the one or more of the walls 407 of the channel 405 may vary laterally by a plurality of gradual excursions and incursions out from or towards a longitudinal centerline of the channel 405 along the length thereof. A plurality of elevations and depressions in the trough 406 may be designed in combination (or not) with a plurality of excursions and incursions of the walls 407 to produce predetermined sounds such as a voice, chordal music, a melody, both a voice and melody, an advertisement, a warning, directions, and combinations thereof. These predetermined sounds may be audible to occupants and users of wheeled vehicles having one or more wheels in contact with the device 400. Additionally, as the wheeled vehicle varies its speed, the frequency of any produced sound may also vary with the speed of the vehicle. Thus, it is envisioned that speed signs or other visual informative signals may be provided on respective portions of a roadway or sidewalk to alert users of vehicles of a proper speed to hear the auditory directions, advertisements, etc.

The device 400 may be affixed to a substantially planar surface 440 using a bonding mechanism such as, but not limited to, adhesives, glues, spikes, bolts, other mechanical fasteners, etc. Exemplary surfaces 440 may be, but are not limited to, a sidewalk, roadway, landing strip, or other surface contacted by wheeled vehicles such as a car, Segway, truck, bus, airplane, etc. While not shown, the device 400 may include an elongated substrate, such as a polymer substrate, intermediate the device 400 and surface 440 to which the device 400 is affixed. This substrate may act as an interface between the device 400 and surface 440 and account for any differences in thermal expansion and contraction between the device and surface materials. In another embodiment of the present subject matter, the device 400 may be embedded in the surface 440.

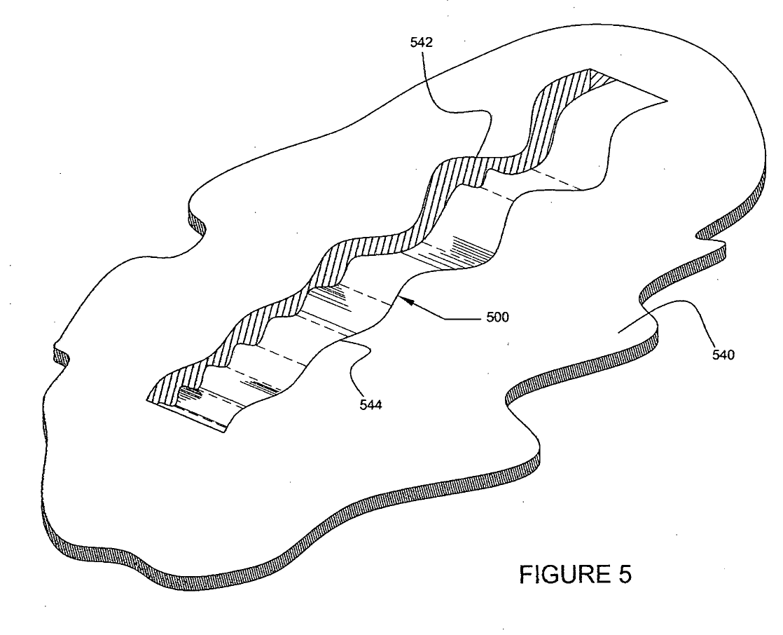

FIG. 5 is a perspective representation of another embodiment of the present subject matter. With reference to FIG. 5, the embodiment may include a surface 540 having a first channel 542 etched therein where a device 500 is affixed in the first channel 542. The device 500 may include a second channel 544 substantially extending down the length of the device 500 where the second channel 544 varies elevationally and laterally along the length of the device to produce sound when contacted by a wheel of a vehicle travelling along the length of the device 500. In one embodiment, the shape of the first and second channels 542, 544 may be substantially similar; therefore, each may vary elevationally by a plurality of gradual rises and falls along the length of the device 500 and may vary laterally by a plurality of gradual excursions and incursions out from or towards a longitudinal centerline of the second channel 544 along the length thereof. While not shown, an elongated substrate may also be provided between the device 500 and the surfaces of the first channel 542 to act as an interface between the device 500 and surface 540 and account for any differences in thermal expansion and contraction between the device and surface materials. In another embodiment, the device 500 may be substantially similar to the device 500 depicted in FIG. 4.

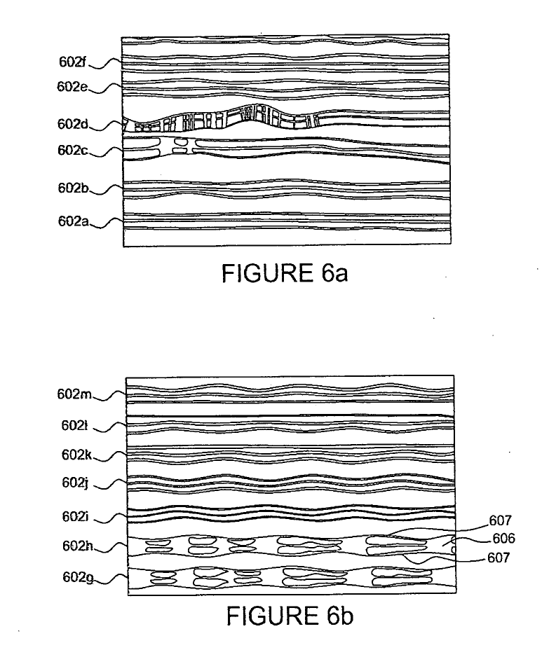

FIGS. 6a-6c are top plan depictions of a plurality of exemplary channels placed side-by-side. With reference to FIGS. 6a-6c, any one of the exemplary channels 602a-602t in FIGS. 6a-6c may be substituted for the channels 405, 542, 544 depicted in FIGS. 4 and 5. For example, with reference to FIG. 6b, an exemplary channel 602h may have walls 607 that vary laterally along the length of the channel 602h. Further, the trough 606 of the channel 602h may also vary elevationally along the length of the channel 602h.

Devices according to embodiments of the present subject matter, whether the embodiments include channels, ridges, etc., may be fabricated by any known means. For example, one may utilize engineering software to create one or more casts or engravings wherein, for a predetermined speed, an exemplary device may be cast/manufactured with varying dimensions for the ridges and/or channels to produce predetermined sounds such as a voice, chordal music, a melody, both a voice and melody, an advertisement, a warning, directions, and combinations thereof.

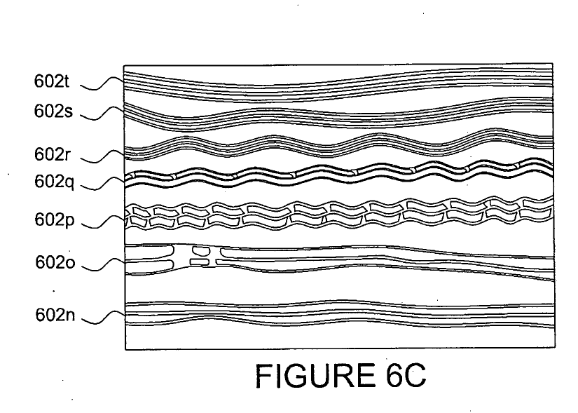

FIG. 7 is a block diagram depicting an embodiment of the present subject matter. With reference to FIG. 7, one embodiment may include a method 700 for reproducing sound. At step 710, a surface, such as a sidewalk, roadway or landing strip, may be provided upon which vehicular traffic can travel. At step 720, an elongated strip of material may be affixed to or embedded in the surface, the elongated strip comprising a ridge substantially extending the length and width of the elongated strip, and the ridge having an elevation varying along the length of the elongated strip. At step 730, sound may then be produced when the elongated strip is contacted by a wheel of a vehicle travelling along the length of the elongated strip. An exemplary produced sound may be a voice, chordal music, a melody, both a voice and melody, an advertisement, a warning, voiced directions, and combinations thereof. Further, the frequency of the produced sound may vary with the speed of the vehicular traffic.

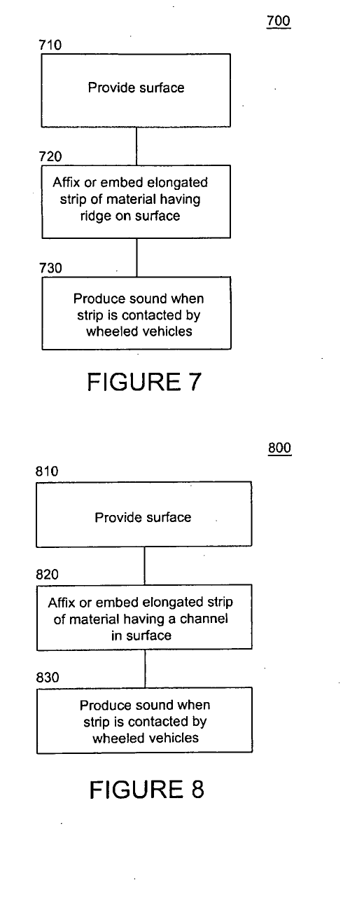

FIG. 8 is a block diagram depicting a further embodiment of the present subject matter. With reference to FIG. 8, one embodiment may include a method 800 for reproducing sound. At step 810, a surface such as a sidewalk, roadway or landing strip, may be provided upon which vehicular traffic can travel. At step 820, an elongated strip of material may be embedded in or affixed to the surface, the elongated strip comprising a channel substantially extending the length of the elongated strip, the channel having a trough that varies elevationally by a plurality of gradual rises and falls along the length of the elongated strip and having one or more walls that vary laterally by a plurality of gradual excursions and incursions out from or towards a longitudinal centerline of the channel along the length of the elongated strip. At step 830, sound may then be produced when the elongated strip is contacted by a wheel of a vehicle travelling along the length of the elongated strip. An exemplary produced sound may be a voice, chordal music, a melody, both a voice and melody, an advertisement, a warning, voiced directions, and combinations thereof. Further, the frequency of the produced sound may vary with the speed of the vehicular traffic.

As shown by the various configurations and embodiments illustrated in FIGS. 1-8, a system, device and method for providing audible sounds from a surface have been described.

While preferred embodiments of the present subject matter have been described, it is to be understood that the embodiments described are illustrative only and that the scope of the invention is to be defined solely by the appended claims when accorded a full range of equivalence, many variations and modifications naturally occurring to those of skill in the art from a perusal hereof.

I claim:

1. A device for reproducing sound comprising an elongated strip of material, said elongated strip having a ridge substantially extending the length and width of said elongated strip, wherein the elevation of said ridge varies along the length of said elongated strip to produce sound when contacted by a wheel of a vehicle travelling substantially along the length of said elongated strip.

2. The device of claim 1 wherein said elongated strip is formed from substantially incompressible material.

3. The device of claim 2 wherein said material is selected from the group consisting of: aluminum, steel, other metals, polymers, concrete, asphalt and combinations thereof.

4. The device of claim 1 further comprising a bonding mechanism to affix said elongated strip in or on a surface.

5. The device of claim 4 wherein said bonding mechanism is a mechanical fastener or an adhesive.

6. The device of claim 4 wherein said surface is a sidewalk, roadway, or landing strip.

7. The device of claim 1 wherein said produced sound is selected from the group consisting of: a voice, chordal music, a melody, both a voice and melody, an advertisement, a warning, directions, and combinations thereof.

8. The device of claim 1 further comprising an elongated substrate intermediate said elongated strip and a surface to which said elongated strip is affixed.

9. The device of claim 1 wherein the frequency of said produced sound varies with the speed of said vehicle.

10. The device of claim 1 wherein said ridge varies elevationally by a plurality of gradual rises and falls along the length of said elongated strip.

11. A device for reproducing sound comprising an elongated strip of material, said elongated strip having a channel substantially extending down the length of said elongated strip, wherein a portion of said channel varies elevationally and laterally to produce sound when contacted by a wheel of a vehicle travelling substantially along the length of said elongated strip.

12. The device of claim 11 wherein said elongated strip is formed from substantially incompressible material.

13. The device of claim 12 wherein said material is selected from the group consisting of: aluminum, steel, other metals, polymers, concrete, asphalt and combinations thereof.

14. The device of claim 12 further comprising a bonding mechanism to affix said elongated strip in or on a surface.

15. The device of claim 14 wherein said bonding mechanism is a mechanical fastener or an adhesive.

16. The device of claim 14 wherein said surface is a sidewalk, roadway, or landing strip.

17. The device of claim 11 wherein said produced sound is selected from the group consisting of: a voice, chordal music, a melody, both a voice and melody, an advertisement, a warning, directions, and combinations thereof.

18. The device of claim 11 further comprising an elongated substrate intermediate said elongated strip and a surface to which said elongated strip is affixed.

19. The device of claim 11 wherein the frequency of said produced sound varies with the speed of said vehicle.

20. The device of claim 11 wherein a trough of said channel varies elevationally by a plurality of gradual rises and falls along the length of said elongated strip and one or more walls of said channel vary laterally by a plurality of gradual excursions and incursions out from or towards a longitudinal centerline of said channel along the length of said elongated strip.

21. A system for reproducing sound comprising:
a surface having a first channel etched therein; and
an elongated strip of material affixed in said first channel, said elongated strip having a second channel substantially extending down the length and width of said elongated strip, said second channel varying elevationally along the length of said elongated strip to produce sound when contacted by a wheel of a vehicle travelling substantially along the length of said elongated strip.

22. The system of claim 21 wherein said elongated strip is formed from substantially incompressible material.

23. The system of claim 22 wherein said material is selected from the group consisting of: aluminum, steel, other metals, polymers, concrete, asphalt and combinations thereof.

24. The system of claim 21 wherein said surface is a sidewalk, roadway, or landing strip.

25. The system of claim 21 wherein said produced sound is selected from the group consisting of: a voice, chordal music, a melody, both a voice and melody, an advertisement, a warning, directions, and combinations thereof.

26. The system of claim 21 wherein the frequency of said produced sound varies with the speed of said vehicle.

27. The system of claim 21 wherein the shape of the first and second channels are substantially similar.

28. The system of claim 21 wherein said second channel varies elevationally by a plurality of gradual rises and falls along the length of said elongated strip.

29. A system for reproducing sound comprising:
a surface having a first channel etched therein; and
an elongated strip of material affixed in said first channel, said elongated strip having a second channel substantially extending down the length said elongated strip, said second channel varying elevationally and laterally to produce sound when contacted by a wheel of a vehicle travelling substantially along the length of said elongated strip.

30. The system of claim 29 wherein said elongated strip is formed from substantially incompressible material.

31. The system of claim 30 wherein said material is selected from the group consisting of: aluminum, steel, other metals, polymers, concrete, asphalt and combinations thereof.

32. The system of claim 29 wherein said surface is a sidewalk, roadway, or landing strip.

33. The system of claim 29 wherein said produced sound is selected from the group consisting of: a voice, chordal music, a melody, both a voice and melody, an advertisement, a warning, directions, and combinations thereof.

34. The system of claim 29 wherein the frequency of said produced sound varies with the speed of said vehicle.

35. The system of claim 29 wherein the shape of the first and second channels are substantially similar.

36. The system of claim 29 wherein a trough of said second channel varies elevationally by a plurality of gradual rises and falls along the length of said elongated strip and one or more walls of said second channel vary laterally by a plurality of gradual excursions and incursions out from or towards a longitudinal centerline of said second channel along the length of said elongated strip.

37. A method for reproducing sound comprising:
providing a surface upon which vehicular traffic can travel;
affixing an elongated strip of material to the surface, the elongated strip comprising a ridge substantially extending the length and width of the elongated strip, and the ridge having an elevation varying along the length of the elongated strip; and
producing sound when the elongated strip is contacted by a wheel of a vehicle travelling along the length of the elongated strip.

38. The method of claim 37 wherein the surface is a sidewalk, roadway, or landing strip.

39. The method of claim 37 wherein the produced sound is selected from the group consisting of: a voice, chordal music, a melody, both a voice and melody, an advertisement, a warning, voiced directions, and combinations thereof.

40. The method of claim 37 wherein the frequency of the produced sound varies with the speed of the vehicular traffic.

41. The method of claim 37 wherein the step of affixing further comprises embedding the elongated strip into the surface.

42. A method for reproducing sound comprising:
providing a surface upon which vehicular traffic can travel;
embedding an elongated strip of material into the surface, the elongated strip comprising a channel substantially extending the length of the elongated strip, the channel having a trough that varies elevationally by a plurality of gradual rises and falls along the length of the elongated strip and having one or more walls that vary laterally by a plurality of gradual excursions and incursions out from or towards a longitudinal centerline of the channel along the length of the elongated strip; and
producing sound when the elongated strip is contacted by a wheel of a vehicle travelling along the length of the elongated strip.

43. The method of claim 42 wherein the surface is a sidewalk, roadway, or landing strip.

44. The method of claim 42 wherein the produced sound is selected from the group consisting of: a voice, chordal music, a melody, both a voice and melody, an advertisement, a warning, voiced directions, and combinations thereof.

45. The method of claim 42 wherein the frequency of the produced sound varies with the speed of the vehicular traffic.
